(19) United States
(12) Patent Application Publication
(10) Pub. No.: US 2025/0054316 A1
(43) Pub. Date: Feb. 13, 2025

(54) CIRCUITRY, SYSTEM, AND METHOD

(71) Applicant: Sony Semiconductor Solutions Corporation, Atsugi-shi, Kanagawa (JP)

(72) Inventors: Serge HUSTIN, Stuttgart (DE); Dmitry KOVALEV, Stuttgart (DE); Morgan CARPENTER, Stuttgart (DE)

(73) Assignee: Sony Semiconductor Solutions Corporation, Atsugi-shi, Kanagawa (JP)

(21) Appl. No.: 18/719,837

(22) PCT Filed: Dec. 6, 2022
(86) PCT No.: PCT/EP2022/084541

§ 371 Date: Jun. 14, 2024

(30) Foreign Application Priority Data
Dec. 23, 2021 (EP) 21217419.7

(51) Int. Cl. G06V 20/58; G06T 7/246; G06V 10/75; G06V 10/80; G06V 40/10

(52) U.S. Cl. CPC G06V 20/58; G06T 7/251; G06V 10/751; G06V 10/803; G06V 40/10; G06T 2207/10028; G06T 2207/30196; G06T 2207/30252

(57) ABSTRACT

The present disclosure pertains to a circuitry for processing a target region configured to: determine a deviation in a scene based on background model data and current image data of the scene: determine a movement in the scene based on Doppler radar data of the scene; and determine a target region in the scene based on at least one of the determined deviation and the determined movement.

### TECHNICAL FIELD

The present disclosure generally pertains to a circuitry, a system and a method, and more particularly, to a circuitry, a system and a method for processing a target region.

### TECHNICAL BACKGROUND

It is generally known in the field of image processing to perform foreground detection and background subtraction for identifying moving objects in a succession of images.

For example, it is known to take an image as reference background, to subtract the reference background from another image, and to consider all pixels of the other image as foreground whose difference to the reference background exceeds a threshold.

Although there exist techniques for identifying moving objects in a succession of images, it is generally desirable to provide a circuitry, a system and a method for processing a target region.

### SUMMARY

According to a first aspect, the disclosure provides a circuitry for processing a target region configured to: determine a deviation in a scene based on background model data and current image data of the scene; determine a movement in the scene based on Doppler radar data of the scene; and determine a target region in the scene based on at least one of the determined deviation and the determined movement.

According to a second aspect, the disclosure provides a system for processing a target region, the system comprising: a circuitry for processing a target region configured to: determine a deviation in a scene based on background model data and current image data of the scene; determine a movement in the scene based on Doppler radar data of the scene; and determine a target region in the scene based on at least one of the determined deviation and the determined movement; an image sensor for acquiring the background model data and the current image data; and a radar sensor for acquiring the Doppler radar data; wherein the circuitry is configured to obtain the background model data and the current image data from the image sensor and obtain the Doppler radar data from the radar sensor.

According to a third aspect, the disclosure provides a method for processing a target region including: determining a deviation in a scene based on background model data and current image data of the scene; determining a movement in the scene based on Doppler radar data of the scene; and determining a target region in the scene based on at least one of the determined deviation and the determined movement.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 is a block diagram of a system and a circuitry according to an embodiment;

FIG. 2 illustrates diagrams of a scene according to an embodiment;

FIG. 3 is a block diagram of a method according to an embodiment;

FIG. 4 is a flow diagram of a method for scene monitoring according to an embodiment;

FIG. 5 is a block diagram depicting an example of schematic configuration of a vehicle control system; and

FIG. 6 is a diagram of assistance in explaining an example of installation positions of an outside-vehicle information detecting section and an imaging section.

### DETAILED DESCRIPTION OF EMBODIMENTS

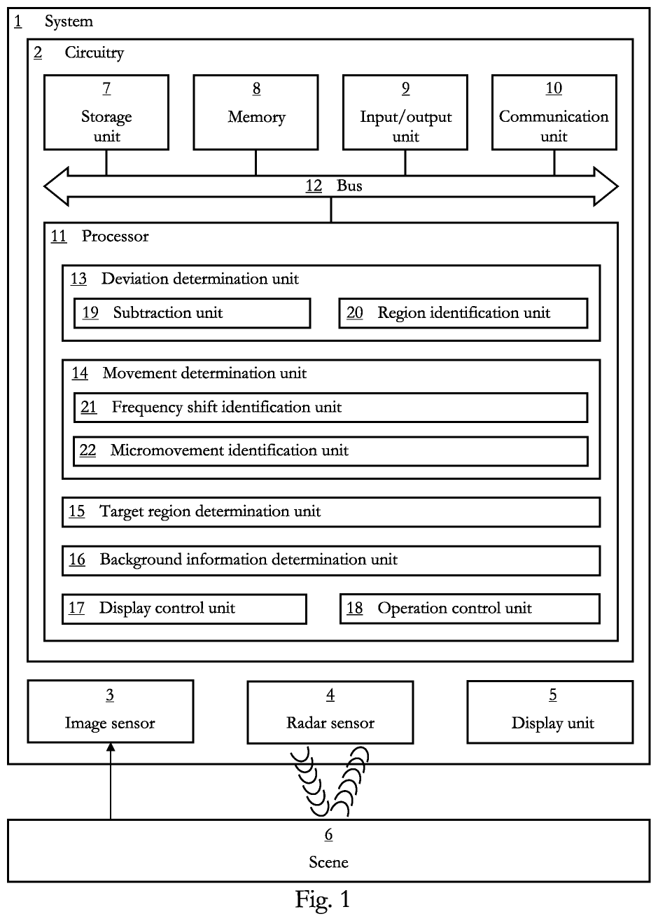

Before a detailed description of the embodiments under reference of FIG. 1 is given, general explanations are made.

As discussed in the outset, it is generally known in the field of image processing to perform foreground detection and background subtraction for identifying moving objects in a succession of images.

For example, it is known to take an image as reference background, to subtract the reference background from another image, and to consider all pixels of the other image as foreground whose difference to the reference background exceeds a threshold.

However, it has been recognized that, in some instances, techniques of foreground detection and background subtraction can be prone to misidentification. For example, a foreground object may be misclassified as part of a background if the foreground object is recorded in a reference background image or a background may be misclassified as part of a foreground if the background is hidden by a foreground object at the time of acquiring a reference background image but becomes visible when the foreground object moves.

An approach for avoiding, or at least reducing, a background/foreground misclassification is based on (re) starting acquiring a background at a time when it is known that there are no foreground objects in a scene, e.g. in a car when unlocking the doors and before people enter the car.

Another approach is based on updating a classification when a misclassification is detected, e.g. when a detected background moves or when a detected foreground does not move for a certain period.

However, it has been recognized that, in some instances, these approaches may fail if a foreground detection has not been performed yet for a scene. For example, when performing an initial foreground detection on an image, a foreground object in the scene may be temporally misclassified as background until a movement of the foreground object is detected. Similarly, a foreground object that has not moved since a start of recording images of the scene may be misclassified as background. Also, a foreground object that had already been classified as foreground may be reclassified as background if it remains static long enough.

It has been recognized that in the latter two situations (foreground object that has not moved since a start of recording images, foreground object reclassified as background), immobile people may not be detected as foreground and may be misclassified as background. This may impede fulfillment of safety requirements, for example when a robot, an autonomous vehicle or a surveillance system ignore immobile people that have been misclassified as background, even if a detection of immobile people is necessary.

For example, an immobile human, i.e. a human who does not change their position, that has been misclassified as background may start moving at an arbitrary point of time. Then, because the human has been misclassified as background, the movement of the human may be detected only with a delay or may not be detected at all. Hence if, e.g., an autonomous apparatus is operated based on the classified background, the human may be hurt by the operation of the autonomous apparatus because the movement of the human may be detected too late or not at all, in some embodiments. Likewise, an immobile animal misclassified as background may start moving at an arbitrary point of time and may be detected only with a delay or not at all.

In some embodiments, a radar sensor may be provided which covers the same scene as an image sensor (or a camera) which acquires images for foreground detection. The radar sensor may be configured to perform Doppler radar measurements, which include detecting micromovements, e.g. breathing, small/micro movements of the body, or a heartbeat. A small/micro movement of the body may be observed on a human as a human cannot stand perfectly still. In some embodiments, the ability of detecting micromovements with a Doppler radar measurement may be suitable for preventing a generation of a background model that includes an immobile human or animal misclassified as background, and for preventing subsequent steps in a computer vision pipeline relying on background subtraction from ignoring the immobile human or animal. Therefore, in some embodiments, when a micromovement is detected by a Doppler radar measurement, foreground detection or generation of a background model may be prevented for avoiding misclassification of an immobile human as background.

Consequently, some embodiments of the present disclosure pertain to a circuitry for processing a target region configured to: determine a deviation in a scene based on background model data and current image data of the scene; determine a movement in the scene based on Doppler radar data of the scene; and determine a target region in the scene based on at least one of the determined deviation and the determined movement.

The circuitry may include any entity capable of performing processing of image data and Doppler radar data. For example, the circuit may include a central processing unit (CPU), a graphics processing unit (GPU), a complex instruction set computer (CISC), a reduced instruction set computer (RISC), a field-programmable gate array (FPGA) and/or an application-specific integrated circuit (ASIC).

The target region may be a region in a scene in which a target is detected. The target may include a human, an animal or an object.

The background model data may be based on first image data that represent a first image of the scene or on the first image data and second image data that represent a second image of the scene.

The background model data may represent a background model, e.g. a background model of the scene, or may provide a basis for generating a background model, e.g. a background model of the scene. For example, the background model may include a single (background) image, which may include the first image represented by the first image data. For example, the background model may include an average and a standard deviation of several (background) images, which may include at least the first and the second image represented by the first and the second image data, respectively. The background model may also include timing data.

The current image data may include the second image data and may represent an image of the scene at a time when the target region is performed. For example, the current image data may be acquired shortly before determining the target region, such that it can be assumed that the scene does not change between acquiring the current image data and determining the target region. Therefore, the current image data may be actual when determining the target region.

The first image data and the second image data may represent images of the scene at different points of time and may be acquired by an image sensor. The first and second image data may include color information, e.g. according to the red-green-blue (RGB) color model, and may be acquired by an RGB image sensor. The first and second image data may include black-and-white (B/W) information, e.g. containing up to 2, 256, 4096, 16384 or 65536 different grayscale shades (without limiting the present disclosure in that regard), and may be acquired by a B/W image sensor. The first and second image data may include infrared (IR) information or temperature information and may be acquired by an IR image sensor or a thermographic image sensor. The first and second image data may include depth information, e.g. based on a time-of-flight (ToP) measurement, and may be acquired by a ToF image sensor. The depth information may be based on Light Detection and Ranging (LiDAR).

The first image data may be acquired at and may relate to a first point of time and the second image data may be acquired at and may relate to a second point of time after the first point of time, i.e., the first image data may be acquired earlier than the second image data. A time period between the first time point and the second time point may be predetermined, e.g., the second point of time may be a predetermined number of milliseconds or seconds after the first point of time, or the second point of time may be a predetermined number frames after the first point of time.

The deviation may represent a change in the scene, e.g. caused by the target. The deviation may be determined to be zero if no change in the scene is detected based on the first and second image data. The deviation may represent a change in the scene within the predetermined time period between an acquisition of the first and the second image data. If a configuration of the scene is changed, the deviation may indicate the change during the predetermined time period and may not indicate the change any more after the predetermined time period has expired.

For example, if a human brings a static object, that does not exhibit micromovements, into the scene and leaves the scene again, whereas the static object remains in the scene, a deviation determined during the predetermined time period after the static object has been brought into the scene may be based on first image data acquired before the static object has been brought into the scene and on second image data acquired after the static object has been brought into the scene. Therefore, the deviation determined during the predetermined time period after the static object has been brought into the scene may indicate a change in the scene caused by bringing the static object into the scene. However, a deviation determined more than the predetermined time period after the static object has been brought into the scene may be based on first and second image data that both have been acquired after the static object has been brought into the scene. Therefore, the deviation determined more than the predetermined time period after the static object has been brought into the scene may not indicate a change caused by bringing the static object into the scene any more.

The Doppler radar data may be radar data acquired by a radar sensor. The radar sensor may be configured to emit a radar signal into the scene and to receive a reflection of the radar signal from the scene. The radar sensor may be configured to determine, based on the received reflection, a distance, a direction and a movement (e.g., a radial movement) of a target. The distance may be a distance between the radar sensor and the target. The direction may be an angle of arrival of the received reflection of the radar signal and may represent an angle in a field of view of the radar sensor at which the target is located. The movement of the target may be a radial velocity of the target (or a part of the target), i.e. a change in the distance between the radar sensor and the (part of the) target, and may be determined based on a frequency shift, caused by the Doppler effect, between the emitted radar signal and the received reflection. Thus, the Doppler radar data may indicate a region in the scene where a movement of the target is detected. The radar sensor may be configured to detect a frequency shift caused by micromovements, e.g. a heartbeat, a breathing, or any other micro displacements of a human body. The Doppler radar data may be acquired at a same point of time as the current image data.

The radar sensor may include a Time Division Multiplexing (TDM) Multiple-Input Multiple-Output (MIMO) Doppler radar sensor or may be configured according to any multiplexing strategy, e.g. Frequency Division Multiplexing (FDM) or Code Division Multiplexing (CDM). The radar sensor may include a Pulsed Doppler radar sensor.

The movement may be determined to be zero if a target is not detected based on the Doppler radar data.

An optical axis of the image sensor and an optical axis of the radar sensor may be parallel or may intersect, e.g. in a center of the scene or in a portion of interest of the scene.

The first and second image data may be acquired by a plurality of image sensors. The Doppler radar data may be acquired by a plurality of radar sensors.

The target region in the scene may be determined to include at least one of a region of the scene where a deviation is determined, based on the first and second image data, and a region of the scene where a movement is determined, based on the Doppler radar data.

In some embodiments, the determining of the deviation is based on a difference between the background model data and the current image data. For example, the difference between the background model data and the current image data may be calculated by subtracting values of corresponding pixels of the first and second image data from each other.

In some embodiments, the determining of the deviation includes identifying, for detecting a change in the scene, a region of the scene in which the difference between the background model data and the current image data meets a predefined criterion. For example, the region of the scene may be represented in the background model data and current image data by a set of pixels that correspond to light from the region of the scene. The difference may meet the predefined criterion if the difference exceeds a predefined threshold for one or more pixels. The predefined criterion may require that the difference exceeds the threshold for at least a predefined number of pixels for avoiding that fluctuations in single pixels are identified as deviations in the scene. The predefined criterion may require that the difference deviates from an average difference between the first and the second image data to increase a robustness against brightness fluctuations between the first and the second image data. The threshold may be calculated, for example, based on a standard deviation of differences between the first and the second image data for a plurality of pixels. The predefined criterion may also be defined by a predefined artificial neural network.

In some embodiments, the determining of the movement is based on a frequency shift identified in the Doppler radar data. The frequency shift may be a shift of a frequency component or frequency spectrum of a received reflection of a radar signal with respect to a radar signal emitted into the scene. The frequency shift may be caused by the Doppler effect and may depend on a radial velocity of the target or of a part of the target with respect to the radar sensor. Hence, the frequency shift may indicate a movement of the target or of a (movable) part of the target.

In some embodiments, the determining of the movement includes identifying, based on a repetition pattern of the identified frequency shift, at least one of a heartbeat and a breathing. For example, a heartbeat or a breathing may be identified if a transient frequency shift repeatedly occurs at a rate that corresponds to a typical pulse rate or breathing rate, respectively. An identification of a heartbeat and a breathing may also be based on a frequency shift that transitions into a frequency shift of an opposite direction, thus indicating a back-and-forth movement such as a rising and falling of a chest during breathing. In some embodiments, a target may be determined if both a heartbeat and a breathing are identified, because known humans and some known animals may exhibit both a heartbeat and a breathing.

In some embodiments, the determining of the target region includes determining, as the target region, a region in the scene that corresponds to at least one of the determined deviation and the determined movement. Thus, a robustness of determining the target region may increase. For example, if a human or an animal in the scene does not move and, accordingly, does not cause a difference between the first and the second image data, a heartbeat or breathing of the human or animal may still be determined in the Doppler radar data. Likewise, if an object moves in the scene perpendicularly to a direction between the radar sensor and the object, thereby showing no radial velocity and not causing a frequency shift, the position change of the object may cause a difference between the first and the second image data. Therefore, by determining, as the target region, a region in the scene that corresponds to at least one of the determined deviation and the determined movement, the target region may be determined, in some embodiments, even in a case where either one of the deviation and the movement is zero and, thus, fails to indicate the target.

In some embodiments, the background model data relate to a first point of time and the current image data relate to a second point of time different from the first point of time. Therefore, if a target in the scene moves between the first point of time and the second point of time, a portion (e.g. one or more pixels) of the background model data corresponding to the target may differ from a portion of the current image data corresponding to the target. Thus, a movement of the target between the first and the second point of time may be detectable based on the background model data and current image data. The first point of time may be a point of time when the background model data are acquired, e.g. when the first image data are acquired. If the background model (data) is/are based on image data acquired at different points of time, e.g. on the first image data and the second image data, the first point of time may be an average of the different points of time at which the image data are acquired, or may be a point of time at which the last image data are acquired.

In some embodiments, the background model is a background image of the scene. In some embodiments, the background model can contain not only one frame but be built based on a sequence of image frames (representing the static scene). In some embodiments, the background model is the resulting image of an active learning of a scene over multiple images.

In some embodiments, the circuitry is further configured to update a background model, based on the current image data and on at least one of the determined deviation and the determined movement. For example, the circuitry may be configured to determine, based on the determined deviation and the determined movement, background information represented by at least one of the first and the second image data of the scene for generating the background model. The background information may indicate a portion of the scene in which no target (human, animal, object) is present, and may be based on a portion of the first and/or second image data that is not included in a determined target region. The background model may be generated and/or updated based on the background information. The background model may be generated for detecting changes in the scene based on image data of the scene.

For example, the background model may be generated in the beginning of a processing that includes monitoring changes in the scene by comparing repeatedly acquired image data with the background model. For avoiding incorporating targets (humans, animals, (moving) objects) in the scene into the background model, a generation of the background model may be prevented if a target region is determined or may be prevented at least for the target region. If the processing includes updating the background model, e.g. when it is detected that a portion of the scene has changed with respect to the background model and has remained static since the change for, e.g., at least a predetermined amount of time, an update of the scene, or of a portion of the scene that corresponds to the target region, may be prevented if a target region is determined.

In some embodiments, the circuitry is further configured to control, based on the determined target region, at least one of a display of the determined target region and an operation of an autonomous apparatus. For example, the controlling may include controlling a display device to display the scene and an indication of the determined target region in the scene, e.g. by displaying a frame around a portion of the scene that corresponds to the determined target region or by displaying a portion of the scene that does not correspond to the determined target region with a lower brightness, lower contrast and/or lower color saturation than a portion of the scene that does correspond to the determined target region. For example, the autonomous apparatus may include a robot, a computer-controlled machine and/or a self-driving vehicle, an operation area of the autonomous apparatus may overlap with the scene, and the autonomous apparatus may pause, stop, or not start at all, an operation if the target region is determined in the scene, or at least in the operation area of the autonomous apparatus. For example, before initially starting the autonomous apparatus, a determination of a target region in the scene may be attempted, and the autonomous apparatus may start an operation in the operation area if no target region is determined, but if a target region is determined, the autonomous apparatus may not be started, or the start of the autonomous apparatus may be postponed to a later point of time when no target region is determined any more in the scene or at least in the operation area of the autonomous apparatus. Here, an operation of the autonomous apparatus may include driving or locomotion of the autonomous apparatus within the operation area, or may include moving a part of the autonomous apparatus, e.g. a robotic arm, within the operation area.

Some embodiments pertain to a system for processing a target region, the system including: a circuitry for processing a target region configured to: determine a deviation in a scene based on background model data and current image data of the scene; determine a movement in the scene based on Doppler radar data of the scene; and determine a target region in the scene based on at least one of the determined deviation and the determined movement; an image sensor for acquiring the background model data and the current image data; and a radar sensor for acquiring the Doppler radar data; wherein the circuitry is configured to obtain the background model data and the current image data from the image sensor and obtain the Doppler radar data from the radar sensor, as described herein.

The circuitry may have the configuration as described for the circuitry above. The image sensor and the radar sensor may have the configurations as described above for the image sensor and the radar sensor, respectively.

The circuitry may obtain the background model data from the image sensor for generating and/or updating the background model. The background model may be stored outside of the image sensor. Some embodiments pertain to a method for processing a target region including: determining a deviation in a scene based on background model data and current image data of the scene; determining a movement in the scene based on Doppler radar data of the scene; and determining a target region in the scene based on at least one of the determined deviation and the determined movement, as described herein.

The method may be configured as described above for the circuitry and, in some embodiments, each feature which is configured by the circuitry is a feature of the method, such that all explications made for the circuitry fully apply to the method.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the circuitry described above, causes the methods described herein to be performed.

Returning to FIG. 1, there is illustrated a block diagram of a system 1 and a circuitry 2 according to an embodiment. The system 1 includes the circuitry 2, an image sensor 3, a radar sensor 4 and a display unit 5. The image sensor 3 and the radar sensor 4 are arranged at a scene 6 so that the image sensor 3 can acquire first and second image data from the scene 6 and that the radar sensor 4 can acquire Doppler radar data from the scene 6.

The circuitry 2 includes a storage unit 7, a memory 8, an input/output (I/O) unit 9, a communication unit 10, and a processor 11. The circuitry 2 also includes a bus 12 which connects the storage unit 7, the memory 8, the I/O unit 9, the communication unit 10 and the processor 11 to each other as necessary.

The processor 11 includes a deviation determination unit 13, a movement determination unit 14, a target region determination unit 15, a background information determination unit 16, a display control unit 17 and an operation control unit 18. The deviation determination unit 13 includes a subtraction unit 19 and a region identification unit 20. The movement determination unit 14 includes a frequency shift identification unit 21 and a micromovement identification unit 22.

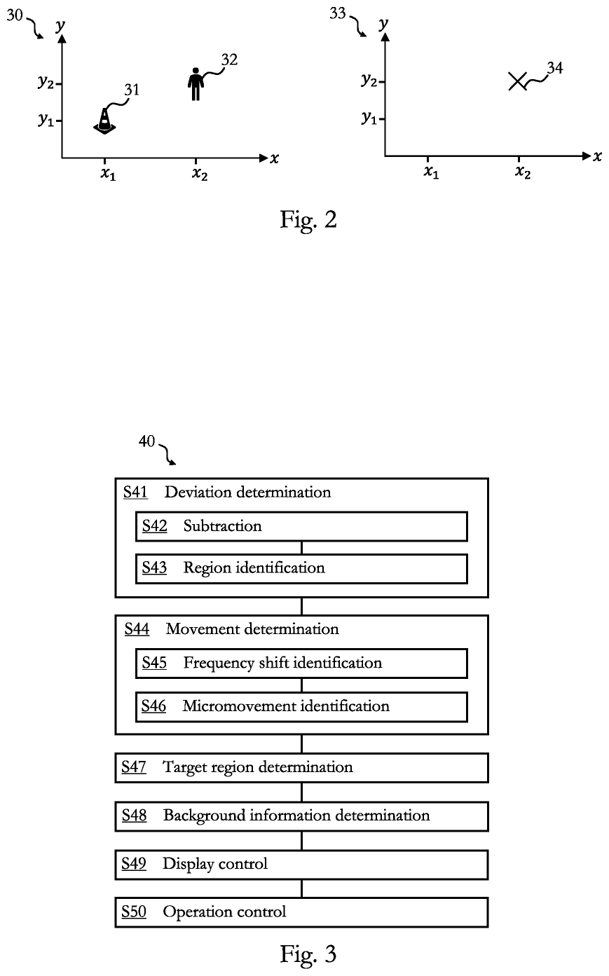

The circuitry 2 is configured to perform a method for processing a target region. In order to enhance the understanding of the present disclosure, an embodiment of the method for processing a target region is discussed under reference to FIGS. 2 to 4 before the detailed description of the system 1 is given.

FIG. 2 illustrates diagrams of a scene according to an embodiment. The left diagram 30 shows an exemplary scene with an immobile object 31 located at a position x₁ in a x-direction and y₁ in a y-direction. The immobile object 31 is an object in a scene that does not move. While the immobile object 31 is illustrated in FIG. 2 as a traffic cone, an immobile object may include, in other embodiments, a traffic sign, a traffic light, a tree, a rock, a parking vehicle, a wall, a building, a bench, a chair, a table, any other piece of furniture, or the like. The left diagram 30 further shows an immobile human 32 located at a position x₂ in the x-direction and y₂ in the y-direction. The immobile human 32 is immobile in that they are standing but not walking. In addition, the arms and legs of the human 32 are also resting instead of moving.

Since both the immobile object 31 and the immobile human 32 are immobile, first and second image data acquired by the image sensor 3 (consecutive in time) do not show a change, between the first and the second image data, of the immobile object 31 and the immobile human 32. A difference between the first and the second image data calculated by the subtraction unit 19 does not indicate the immobile object 31 and the immobile human 32, and the region identification unit 20 fails to identify a region with a deviation in the scene. Therefore, in the embodiment of FIG. 2, the immobile human 32 is not detected based on the first and second image data. Thus, an autonomous apparatus operating in the scene would be controlled as if no human is present in the scene and might, therefore, hurt the immobile human 32.

The right diagram 33 illustrates the same scene as the left diagram 33. However, the diagram 33 illustrates the scene as represented by the Doppler radar data acquired by the radar sensor 4. The diagram 33 does not show an indication at the position x₁ in the x-direction and y₁ in the y-direction because the immobile object 31 does not move and, thus, does not cause a frequency shift in a reflected radar signal due to the Doppler effect. However, the diagram 33 shows an indication 34 of a movement at the position x₂ in the x-direction and y₂ in the y-direction, where the immobile human 32 is located, because, although the immobile human 32 does not change their position, the immobile human 32 performs micromovements, including breathing and a heartbeat, which cause a frequency shift in a reflected radar signal due to the Doppler effect. The radar sensor 4 detects the frequency shift caused by the micromovements and, thus, detects the presence of the immobile human 32.

Hence, although the immobile human 32 is not detected based on a deviation between the first and second image data, the immobile human 32 is detected based on a movement identified in the Doppler radar data. The frequency shift identification unit 21 identifies a frequency shift in a radar signal reflected by the immobile human 32, the micromovement identification unit 22 identifies a micromovement (heartbeat, breathing) of the immobile human 32, the target region determination unit 15 determines a target region in a portion of the scene where the immobile human 32 is located, and the background information determination unit 16 determines background information that does not include the immobile human 32 as misclassified background.

Thus, the operation control unit 18 prevents a generation of a background model as long as the immobile human 32 is present in the scene (i.e., as long as the target region determination unit 15 determines a target region that corresponds to the immobile human 32) and, thereby, prevents the immobile human 32 from being misclassified as background. Therefore, an autonomous apparatus operating in the scene does not ignore the immobile human 32, and, thus, an accident in which the immobile human 32 is hurt when they move arbitrarily can be prevented.

In some embodiments, instead of the immobile human 32, an immobile animal can be detected based on Doppler radar data, and a misclassification of the immobile animal as well as an accident of an autonomous apparatus with the misclassified animal, upon an arbitrary movement of the animal, can be prevented.

In some embodiments, instead of micromovements of the immobile human 32, vibrations of a vehicle caused by a running motor of the vehicle can be detected as micromovements based on Doppler radar data, so that the vehicle with the running motor is not misclassified as background, and if the vehicle starts moving at an arbitrary point in time, the movement of the vehicle can be detected soon enough to prevent an accident with the vehicle.

FIG. 3 is a block diagram of a method 40 according to an embodiment. The method 40 is performed by the circuitry 2 (its processor 11).

At S41, the deviation determination unit 13 performs a deviation determination. In the deviation determination, a deviation in a scene is determined based on first and second image data of the scene, which are acquired by the image sensor 3. The first image data relate to a first point of time and the second image data relate to a second point of time after the first point of time, i.e., the first image data are acquired earlier than the second image data. A time period between the first time point and the second time point is predetermined. In a case where no deviation is present between the first and the second image data, the deviation determination unit 13 determines a deviation of zero for representing that there is no deviation between the first and the second image data.

The deviation determination includes, at S42, a subtraction. The subtraction is performed by the subtraction unit 19 and includes calculating a difference between the first and the second image data, and the deviation determination is based on the calculated difference between the first and the second image data.

The deviation determination includes, at S43, a region identification. The region identification is performed by the region identification unit 20 and includes identifying, for detecting a change in the scene, a region of the scene in which the calculated difference between the first and the second image data meet a predefined criterion. As described above, the predefined criterion includes a predetermined threshold for a difference between the first and the second image data at multiple pixel positions.

At S44, the movement determination unit 14 performs a movement determination. In the movement determination, a movement in the scene is determined based on Doppler radar data of the scene, which are acquired by the radar sensor 4.

The movement determination includes, at S45, a frequency shift identification. The frequency shift identification is performed by the frequency shift identification unit 21 and includes identifying a frequency shift in the Doppler radar data. The frequency shift is a shift of a frequency spectrum of a radar signal received from the scene with respect to a radar signal emitted into the scene, and is caused by a movement in the scene due to the Doppler effect.

The movement determination includes, at S46, a micromovement identification. The micromovement identification is performed by the micromovement identification unit 22 and includes identifying a micromovement, based on a repetition pattern of the frequency shift identified by the frequency shift identification. The micromovement includes a heartbeat, a micromovement of a human's body, and a breathing.

At S47, the target region determination unit 15 performs a target region determination. The target region determination includes determining, as a target region, a region in the scene that corresponds to at least one of the deviation determined in the deviation determination at S41 and the movement determined in the movement determination at S44. That means that the target region is based on both the determined deviation and the determined movement if both a deviation and a movement are determined. In a case where a deviation is determined in the deviation determination at S41 but no movement is determined in the movement determination at S44, the target region is determined based only on the determined deviation. Likewise, in a case where a movement is determined in the movement determination at S44 but no deviation is determined in the deviation determination at S41, the target region is determined based only on the determined movement.

At S48, the background information determination unit 16 performs a background information determination. The background information determination includes determining, based on the deviation determined in the deviation determination at S41 and the movement determined in the movement determination at S44, background information, represented by the first and the second image data of the scene, for generating a background model.

At S49, the display control unit 17 performs a display control. The display control includes controlling, based on the target region determined in the target region determination at S47, a display of the determined target region. The display control includes displaying an image of the scene, based on the first and the second image data, and highlights, in the displayed image of the scene, the determined target region.

At S50, the operation control unit 18 performs an operation control. The operation control includes controlling, based on the target region determined in the target region determination at S47, an operation of an autonomous apparatus. The operation control includes controlling the autonomous apparatus to pause operation if a target region is determined in the scene. The operation control also includes preventing the autonomous apparatus from starting operation if the autonomous apparatus is not operating when a target region is determined in the scene.

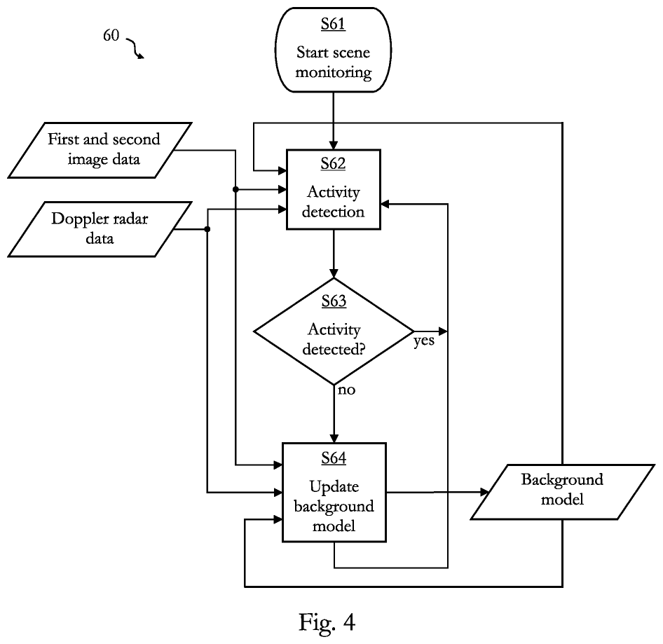

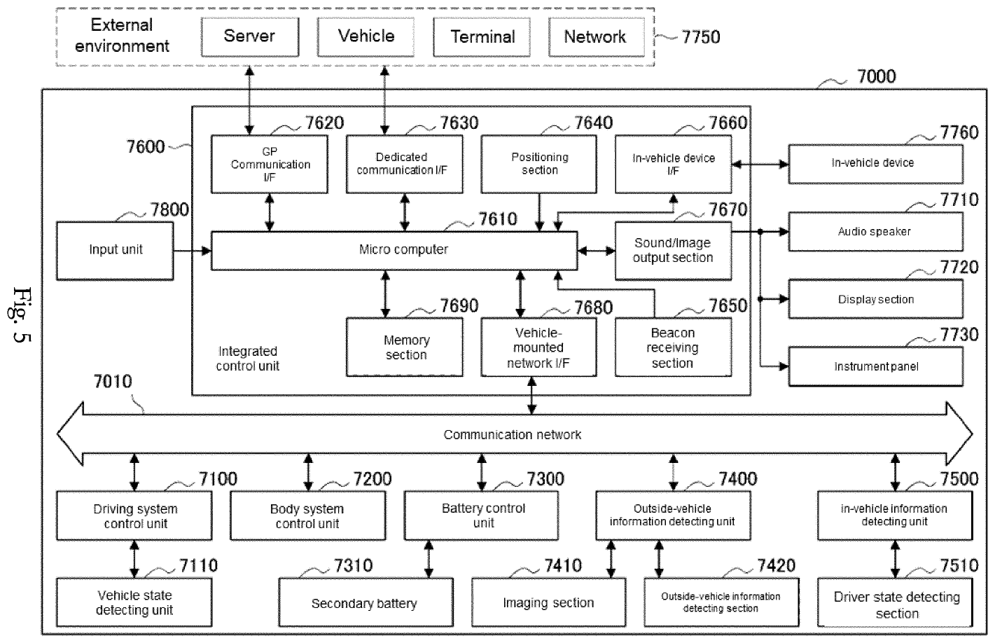

FIG. 4 is a flow diagram of a method 60 for scene monitoring according to an embodiment.

At S61, the scene monitoring of a scene is started.

At S62, an activity detection is performed, based on first and second image data of the scene, on Doppler radar data of the scene and, if a background model of the scene has already been generated, e.g. at S64 described below, also on the background model. The first and second image data are acquired by the image sensor 3, and the Doppler radar data are acquired by the radar sensor 4. The activity detection includes determining a deviation in the scene, such as the deviation determination performed at S41 by the deviation determination unit 13, determining a movement in the scene, such as the movement determination performed at S44 by the movement determination unit 14, and determining a target region in the scene, such as the target region determination performed at S47 by the target region determination unit 15. The activity detection detects an activity (i.e. determines a deviation, a movement and a target region), for a portion of the scene that is covered by both the first and second image data and the Doppler radar data, if a target region is determined, and does not detect an activity if a target region is not determined. If the background model has already been generated, the activity detection also detects an activity by comparing the first and/or second image data with the background model.

At S63, it is decided whether an activity has been detected in the scene by the activity detection of S62. If an activity has been detected, processing returns to S62. If no activity has been detected, the method 60 proceeds to S64.

At S64, a background model of the scene, or at least of a portion of the scene for which the activity detection is performed, is updated. The background model is based on the first and the second image data. The updating of the background model includes generating and setting a portion of the background model that corresponds to a portion of the scene in which a background has changed since a last generation of a corresponding portion of the background model. For updating the background model, the background model is retrieved from the memory 8 of FIG. 1. A portion of the scene in which a background has changed since a last generation of a corresponding portion of the background model is identified by comparing the retrieved background model with the first and/or the second image data, wherein the second image data represents current image data. Based on the Doppler radar data, a portion of the scene eligible for updating the background model is identified as a portion of the scene whose distance from the Doppler radar sensor lies between a first predetermined distance and a second predetermined distance. A portion of the background model that corresponds to a portion of the scene in which a background has changed and which is eligible for updating the background model is (re) generated and set based on the first and/or the second image data. The updating of the background model also includes generating the whole background model, e.g. at the beginning of the method 60 when S64 has not been performed yet and, thus, the background model has not been generated yet. After updating the background model, the updated background model is written to the memory 8.

After S64, the method 60 proceeds to S62.

Thus, the method 60 monitors the scene for an activity (deviation, movement) and updates the background model of the scene if no activity is detected, whereas it prevents, by proceeding from S63 to S62, updating the background model if an activity is detected. Therefore, some embodiments of the method 60 avoid an update of the background model if a human or animal is present in the scene, so as to prevent a misclassification of the human or animal as background.

Therefore, to execute the methods 40 and/or 60 as described above, the system 1 of FIG. 1 is configured as follows:

The storage unit 7 includes a non-transitory flash memory that stores program instructions for execution by the processor 11, parameters and settings used by the program instructions, and data generated by the processor 11.

The memory 8 includes a Random-Access Memory (RAM) that stores a state of a program executed by the processor 11 and temporary data generated or read by the processor 11.

The I/O unit 9 receives instructions and parameters from a user and provides information to the user. For receiving instructions and parameters from the user, the I/O unit 9 includes a keyboard and a mouse. For providing information to the user, the I/O unit 9 includes a graphics card. The I/O unit 9 controls, via the graphics card, a display on a screen included in the display unit 5.

The communication unit 10 includes an interface for communicating with the image sensor 3 and the radar sensor 4 based on a Universal Serial Bus (USB).

The processor 11 executes instructions, which are stored in the storage unit 7 or received from a user via the I/O unit 9, based on the parameters and settings stored in the storage unit 7 or received from the user via the I/O unit 9. The processor 11 stores in and reads from the memory 8 a state of a program executed by the processor 11. The processor 11 generates temporary data, stores them in the memory 8, and reads temporary data from the memory 8. The processor 11 includes a central processing unit (CPU). The processor 11 receives, via the communication unit 10, data from the image sensor 3 and from the radar sensor 4, and processes the received data, which includes generating information. The processor 11 displays, via the I/O unit 9, generated information to the user.

The deviation determination unit 13 includes the subtraction unit 19 and the region identification unit 20. The deviation determination unit 13 receives, from the image sensor 3, first and second image data of the scene 6. The subtraction unit 19 calculates a difference between the first and second image data of the scene 6. The deviation determination unit 13 determines a deviation in the scene 6 based on the calculated difference between the first and second image data. The region identification unit 20 identifies, for detecting a change in the scene 6 (including a motion of a human, an animal or an object in the scene 6), a region of the scene 6 in which the calculated difference between the first and second image data meets a predefined criterion, including a threshold.

The movement determination unit 14 includes the frequency shift identification unit 21 and the micromovement identification unit 22. The movement determination unit 14 receives, from the radar sensor 4, Doppler radar data of the scene 6. The frequency shift identification unit 21 identifies a frequency shift in the Doppler radar data. The frequency shift is caused, according to the Doppler effect, by a motion of a human, an animal or an object in the scene 6 with a radial velocity with respect to the radar sensor 4. Thus, the movement determination unit 14 determines a movement in the scene 6 based on the Doppler radar data of the scene 6. The Doppler radar data also indicates a distance of a target (human, animal or object) whose motion causes the frequency shift and an angle of arrival of a radar signal reflected by the target. The movement determination unit 14 determines, based on the distance of the target and the angle of arrival of the reflected radar signal, a region of the scene 6 in which the target is located. The micromovement identification unit 22 identifies, based on a repetition pattern of the identified frequency shift, a micromovement, which includes a heartbeat and a breathing and, thus, indicates a presence of a human or an animal, even if the human or animal is standing still.

The target region determination unit 15 determines, as target region, a region in the scene 6 that corresponds to at least one of the region determined by the region identification unit 20, in which the deviation is determined, and the region determined by the movement determination unit 14, in which the movement is determined. Thus, the target region determination unit 15 determines a region of the scene 6 in which the micromovement identification unit 22 identifies a heartbeat or a breathing.

The background information determination unit 16 determines, based on the deviation determined by the deviation determination unit 13 and on the movement determined by the movement determination unit 14, background information represented by the first and the second image data of the scene 6 for generating a background model. The background information determination unit 16 determines, as background indicated by the background information, a portion of the scene 6 in which the deviation determination unit 13 does not determine a deviation, in which the movement determination unit 14 does not determine a movement and in which the target region determination unit 15 does not determine a target region. A background model can then be generated based on the background information.

The display control unit 17 controls a display, on the display unit 5, of the target region determined by the target region determination unit 15. The display control unit 17 controls the display unit 5 to display an image calculated from and corresponding to the first and second image data of the scene 6 and highlight the target region in the image. The highlighting includes displaying a frame around the target region. Thus, a controlling person can easily grasp that and where in the scene 6 a target region is determined.

The operation control unit 18 controls, based on the target region determined by the target region determination unit 15, an operation of an autonomous apparatus. The autonomous apparatus is a robot that moves within the scene 6. The operation control unit 18 causes the autonomous apparatus to pause operation if a target region is determined. The operation control unit 18 also prevents a generation of a background model for autonomous operation control of the autonomous apparatus if the target region determination unit 15 determines a target region in the scene 6. By preventing the generation of the background model, the operation control unit 18 prevents a target (human, animal, object) present in the scene 6 from being misclassified as background and, thus, from being ignored in an operation of the autonomous apparatus. Accordingly, preventing the generation of the background model if a target region is determined has the effect that an injury of a human or animal or a damage of an object in the scene 6 can be prevented.

The image sensor 3 acquires first image data of the scene 6 at a first point of time and acquires second image data of the scene 6 at a second point of time later than the first point of time. The image sensor 3 includes a black/white image sensor, and the first and second image data represent black/white image information of the scene 6.

The radar sensor 4 acquires Doppler radar data of the scene 6. The Doppler radar data indicate a radial velocity of a target (human, animal, object) with respect to the radar sensor 4, a distance between the target and the radar sensor 4, and an angle of arrival of a radar signal reflected by the target with respect to an axis of a field of view of the radar sensor 4. Therefore, a (radial) velocity of the target and a position of the target in the scene 6 can be determined based on the Doppler radar data.

The display unit 5 includes a screen configured to display information. The display unit 5 causes the screen to display information according to a signal the display unit 5 receives from the I/O unit 9.

It is noted that, in some embodiments, any of the units 13 to 22 may be provided as a separate unit, may be provided as a same unit as any other of the units 13 to 22, or may be provided by general functionality of the processor 11.

Some embodiments pertain to preventing a generation (or update) of a background model of a scene (or of a portion of the scene) if a human or an animal is present in the scene (or portion of the scene). Some embodiments pertain to preventing the generation (or update) of the background model for controlling a robot. Some embodiments pertain to preventing the generation (or update) of the background model for controlling a self-driving vehicle. Some embodiments pertain to preventing the generation (or update) of the background model in a medical surveillance system (e.g. for monitoring a patient in a room).

The technology according to an embodiment of the present disclosure is applicable to various products. For example, the technology according to an embodiment of the present disclosure may be implemented as a device included in a mobile body that is any of kinds of automobiles, electric vehicles, hybrid electric vehicles, motorcycles, bicycles, personal mobility vehicles, airplanes, drones, ships, robots, construction machinery, agricultural machinery (tractors), and the like.

FIG. 5 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 5, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 5 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

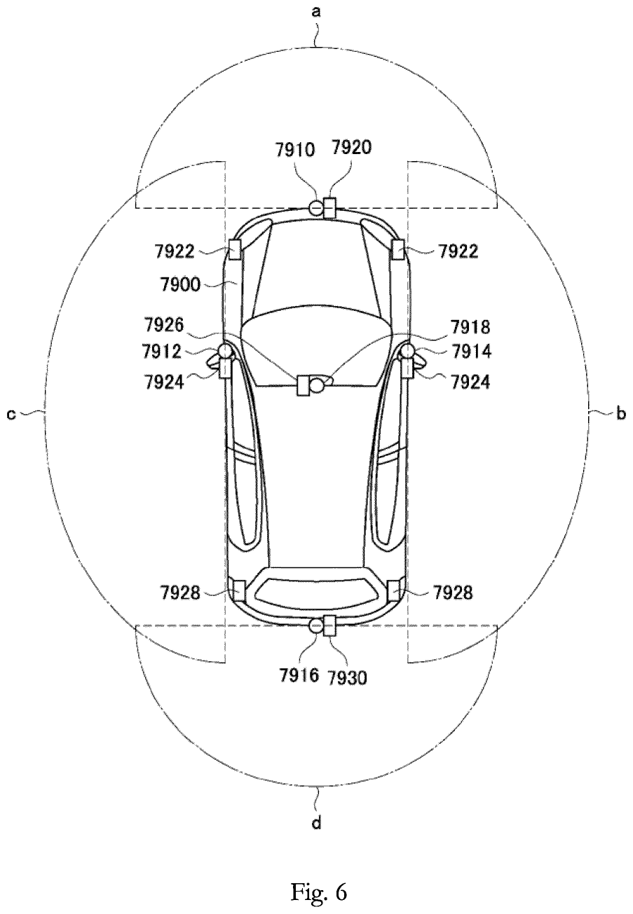

FIG. 6 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 6 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 5, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 5, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 5 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Incidentally, a computer program for realizing the functions of the information processing device 100 according to the present embodiment described with reference to FIG. 5 can be implemented in one of the control units or the like. In addition, a computer readable recording medium storing such a computer program can also be provided. The recording medium is, for example, a magnetic disk, an optical disk, a magneto-optical disk, a flash memory, or the like. In addition, the above-described computer program may be distributed via a network, for example, without the recording medium being used.

It should be recognized that the embodiments describe methods with an exemplary ordering of method steps. The specific ordering of method steps is however given for illustrative purposes only and should not be construed as binding. For example, the ordering of S41 and S44 in the embodiment of FIG. 3 may be exchanged. Also, the ordering of S47 and S48 in the embodiment of FIG. 3 may be exchanged. Further, also the ordering of S49 and S50 in the embodiment of FIG. 3 may be exchanged. Moreover, in some embodiments, the method of FIG. 3 may include only one of S47 and S48, and/or only one of S49 and S50. Other changes of the ordering of method steps may be apparent to the skilled person.

It should also be noted that the division of the processor 11 of FIG. 1 into units 13 to 22 and the division of the control or circuitry 7600 of FIG. 5 into units 7610 to 7690 are only made for illustration purposes and that the present disclosure is not limited to any specific division of functions in specific units. For instance, at least parts of the circuitry could be implemented by a respective programmed processor, field programmable gate array (FPGA), dedicated circuits, and the like.

All units and entities described in this specification and claimed in the appended claims can, if not stated otherwise, be implemented as integrated circuit logic, for example on a chip, and functionality provided by such units and entities can, if not stated otherwise, be implemented by software. In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A circuitry for processing a target region configured to:
determine a deviation in a scene based on background model data and current image data of the scene;
determine a movement in the scene based on Doppler radar data of the scene; and
determine a target region in the scene based on the determined deviation and the determined movement.

(2) The circuitry of (1), wherein the determining of the deviation is based on a difference between the background model data and the current image data.

(3) The circuitry of (2), wherein the determining of the deviation includes identifying, for detecting a change in the scene, a region of the scene in which the difference between the background model data and the current image data meets a predefined criterion.

(4) The circuitry of any one of (1) to (3), wherein the determining of the movement is based on a frequency shift identified in the Doppler radar data.

(5) The circuitry of (4), wherein the determining of the movement includes identifying, based on a repetition pattern of the identified frequency shift, at least one of a heartbeat and a breathing.

(6) The circuitry of any one of (1) to (5), wherein the determining of the target region includes determining, as the target region, a region in the scene that corresponds to at least one of the determined deviation and the determined movement.

(7) The circuitry of any one of (1) to (6), wherein the background model data relate to a first point of time and the current image data relate to a second point of time different from the first point of time.

(8) The circuitry of any one of (1) to (7), further configured to update a background model, based on the current image data and on at least one of the determined deviation and the determined movement.

(9) The circuitry of any one of (1) to (8), further configured to control, based on the determined target region, at least one of a display of the determined target region and an operation of an autonomous apparatus.

(10) A system for processing a target region, the system comprising:
a circuitry for processing a target region configured to:
   determine a deviation in a scene based on background model data and current image data of the scene;
   determine a movement in the scene based on Doppler radar data of the scene; and
   determine a target region in the scene based on at least one of the determined deviation and the determined movement;
an image sensor for acquiring the background model data and the current image data; and
a radar sensor for acquiring the Doppler radar data;
wherein the circuitry is configured to obtain the background model data and the current image data from the image sensor and obtain the Doppler radar data from the radar sensor.

(11) A method for processing a target region comprising:
determining a deviation in a scene based on background model data and current image data of the scene;
determining a movement in the scene based on Doppler radar data of the scene; and
determining a target region in the scene based on at least one of the determined deviation and the determined movement.

(12) The method of (11), wherein the determining of the deviation is based on a difference between the background model data and the current image data.

(13) The method of (12), wherein the determining of the deviation includes identifying, for detecting a change in the scene, a region of the scene in which the difference between the background model data and the current image data meets a predefined criterion.

(14) The method of any one of (11) to (13), wherein the determining of the movement is based on a frequency shift identified in the Doppler radar data.

(15) The method of (14), wherein the determining of the movement includes identifying, based on a repetition pattern of the identified frequency shift, at least one of a heartbeat and a breathing.

(16) The method of any one of (11) to (15), wherein the determining of the target region includes determining, as the target region, a region in the scene that corresponds to at least one of the determined deviation and the determined movement.

(17) The method of any one of (11) to (16), wherein the background model data relate to a first point of time and the current image data relate to a second point of time different from the first point of time.

(18) The method of any one of (11) to (17), further comprising updating a background model, based on the current image data and on at least one of the determined deviation and the determined movement.

(19) The method of any one of (11) to (18), further comprising controlling, based on the determined target region, at least one of a display of the determined target region and an operation of an autonomous apparatus.

(20) A program comprising instructions which, when the program is executed by a computer, cause the computer to perform the method of any one of (11) to (19).

(21) A computer readable storage medium having stored thereon the program of (20).

1. A circuitry for processing a target region configured to:
determine a deviation in a scene based on background model data and current image data of the scene;
determine a movement in the scene based on Doppler radar data of the scene; and
determine a target region in the scene based on at least one of the determined deviation and the determined movement.

2. The circuitry of claim 1, wherein the determining of the deviation is based on a difference between the background model data and the current image data.

3. The circuitry of claim 2, wherein the determining of the deviation includes identifying, for detecting a change in the scene, a region of the scene in which the difference between the background model data and the current image data meets a predefined criterion.

4. The circuitry of claim 1, wherein the determining of the movement is based on a frequency shift identified in the Doppler radar data.

5. The circuitry of claim 4, wherein the determining of the movement includes identifying, based on a repetition pattern of the identified frequency shift, at least one of a heartbeat and a breathing.

6. The circuitry of claim 1, wherein the determining of the target region includes determining, as the target region, a region in the scene that corresponds to at least one of the determined deviation and the determined movement.

7. The circuitry of claim 1, wherein the background model data relate to a first point of time and the current image data relate to a second point of time different from the first point of time.

8. The circuitry of claim 1, further configured to update a background model, based on the current image data and on at least one of the determined deviation and the determined movement.

9. The circuitry of claim 1, further configured to control, based on the determined target region, at least one of a display of the determined target region and an operation of an autonomous apparatus.

10. A system for processing a target region, the system comprising:
a circuitry for processing a target region configured to:
determine a deviation in a scene based on background model data and current image data of the scene;
determine a movement in the scene based on Doppler radar data of the scene; and
determine a target region in the scene based on at least one of the determined deviation and the determined movement;
an image sensor for acquiring the background model data and the current image data; and
a radar sensor for acquiring the Doppler radar data;
wherein the circuitry is configured to obtain the background model data and the current image data from the image sensor and obtain the Doppler radar data from the radar sensor.

11. A method for processing a target region comprising:
determining a deviation in a scene based on background model data and current image data of the scene;
determining a movement in the scene based on Doppler radar data of the scene; and
determining a target region in the scene based on at least one of the determined deviation and the determined movement.

12. The method of claim 11, wherein the determining of the deviation is based on a difference between the background model data and the current image data.

13. The method of claim 12, wherein the determining of the deviation includes identifying, for detecting a change in the scene, a region of the scene in which the difference between the background model data and the current image data meets a predefined criterion.

14. The method of claim 11, wherein the determining of the movement is based on a frequency shift identified in the Doppler radar data.

15. The method of claim 14, wherein the determining of the movement includes identifying, based on a repetition pattern of the identified frequency shift, at least one of a heartbeat and a breathing.

16. The method of claim 11, wherein the determining of the target region includes determining, as the target region, a region in the scene that corresponds to at least one of the determined deviation and the determined movement.

17. The method of claim 11, wherein the background model data relate to a first point of time and the current image data relate to a second point of time different from the first point of time.

18. The method of claim 11, further comprising updating a background model, based on the current image data and on at least one of the determined deviation and the determined movement.

19. The method of claim 11, further comprising controlling, based on the determined target region, at least one of a display of the determined target region and an operation of an autonomous apparatus.
